(19) United States
(12) Patent Application Publication
(10) Pub. No.: US 2018/0128304 A1
(43) Pub. Date: May 10, 2018

(54) THREADED FASTENER WITH HYBRID PATCH

(71) Applicant: Nylok LLC, Macomb, MI (US)

(72) Inventors: Gregory Alaimo, Shelby Township, MI (US); Tadashi Camey, Novi, MI (US); Robin F. Monahan, Richmond, MI (US)

(21) Appl. No.: 15/801,800

(22) Filed: Nov. 2, 2017

Related U.S. Application Data
(60) Provisional application No. 62/420,367, filed on Nov. 10, 2016.

(51) Int. Cl. F16B 39/22; F16B 39/38

(52) U.S. Cl. CPC F16B 39/225; F16B 39/38

(57) ABSTRACT

A threaded fastener with a hybrid locking mechanism includes a shank having a threaded portion, a first locking mechanism disposed on the threaded portion, and a second locking mechanism disposed on the threaded portion extending over the first locking mechanism. The first locking mechanism provides a primary retention strength during an initial use of the threaded fastener and the second locking mechanism provides the primary retention strength during subsequent uses of the threaded fastener. A method of making the threaded fastener includes applying a first locking mechanism material on the shank and applying a second locking mechanism material over the first locking mechanism material on the shank.

### CROSS-REFERENCE TO RELATED APPLICATION DATA

This application claims the benefit of and priority to Provisional U.S. Patent Application Ser. No. 62/420,367, filed Nov. 10, 2016, the disclosure of which is incorporated herein in its entirety.

### BACKGROUND

The following description generally relates to threaded fasteners having two or more locking mechanisms for increasing fastener retention and removal resistance and methods of making the same.

Threaded fasteners are used in numerous applications. However, in some applications, threaded fasteners, and a body or bodies in which they are installed, are subjected to vibrations or impacts. The vibrations or impacts may cause the threaded fastener to rotate in a removal direction within a corresponding threaded opening, thereby loosening the threaded fastener in, or ultimately, removing the threaded fastener from, the opening. This unintentional removal or loosening of the threaded fastener may cause adjacent bodies secured together by the threaded fastener to separate or otherwise move relative to one another which can damage the bodies. As a result, time and resources must be spent to repair the bodies and/or replace the threaded fasteners.

Locking techniques have been developed to improve retention strength of a threaded fastener within an opening and resist unintentional loosening or removal. Such techniques are typically either mechanical or chemical in nature. A known mechanical locking technique includes the introduction of a polymer element at an interface between a male and female thread. The polymer element may be disposed on the threaded section of the fastener and applied thereon by an applicator. The mechanical locking element may be, for example, a patch, a pellet and/or strip. A known polymer element may be, for example, nylon material, and in particular, nylon 11.

The nylon patch is generally circular and typically extends approximately 180 degrees around the fastener. This range generally corresponds to an area of the fastener that is exposed to the nylon applicator. However, mechanical locking techniques, such as those involving a polymeric patch, pellet or strip may not provide sufficient retention strength or resistance to undesired removal or loosening of the threaded fastener. In addition, a higher torque may be required to install a threaded fastener having a mechanical lock, compared to a bare threaded fastener, because of increased friction attributable to the mechanical lock.

A known chemical locking technique involves the use of an adhesive coating on the threaded fastener. A threaded portion of the fastener may be coated with a liquid adhesive slurry having a carrier and adhesive microcapsules therein. As the solvent-based carrier evaporates, the adhesive microcapsules remain on the threaded portion. When the threaded fastener is installed in a corresponding threaded opening, the adhesive microcapsules break, mix together, and flow between the threads of the fastener and corresponding threaded opening. The adhesive microcapsules may include a first set of microcapsules containing, for example, a resin, and a second set of microcapsule containing, for example, a hardener. As the microcapsules break, the resin and hardener mix, causing a chemical reaction to cure the adhesive.

However, chemical locking techniques are only suitable for one-time uses. That is, a threaded fastener with a chemical locking mechanism, such as an adhesive, deposited thereon is only suitable for securing the threaded fastener in a corresponding threaded opening once. The adhesive bond between the threaded fastener and the corresponding threaded opening is broken upon removal of the threaded fastener from the corresponding threaded opening. Thus, when a threaded fastener is repeatedly removed and installed, the fastener must be coated with the adhesive before each installation to realize the desired retention benefits. In addition, chemical locking techniques, such as adhesives, require time to cure. Thus, after installation, a threaded fastener with an adhesive coating must remain undisturbed for a period of time while the adhesive cures. If the fastener is subjected to vibration or impacts before the adhesive cures, the fastener may be just as susceptible to inadvertent loosening or removal as if it were left uncoated. Thus, additional down time for a product or machine in which the fastener is installed is required for the desired retention benefits.

Accordingly, it is desirable to provide a threaded fastener having a hybrid locking mechanism or patch for increasing retention strength and resistance to loosening or removal over multiple uses.

### SUMMARY

According to one aspect, there is provided a threaded fastener having a hybrid locking mechanism including a shank having a threaded portion, a first locking mechanism disposed on the threaded portion and a second locking mechanism disposed on the threaded portion extending over the first locking mechanism. The first locking mechanism provides a primary retention strength during an initial use of the threaded fastener and the second locking mechanism provides the primary retention strength during subsequent uses of the threaded fastener.

According to another aspect, there is provided a method of making a threaded fastener with a hybrid locking mechanism, the threaded fastener including a shank having a threaded portion, a first locking mechanism disposed on the threaded portion, and a second locking mechanism disposed on the threaded portion extending over the first locking mechanism. The method includes applying a first locking mechanism material on the shank and applying a second locking mechanism material over the first locking mechanism material on the shank.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1 is a side view of a threaded fastener having a hybrid locking mechanism according to an embodiment described herein.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

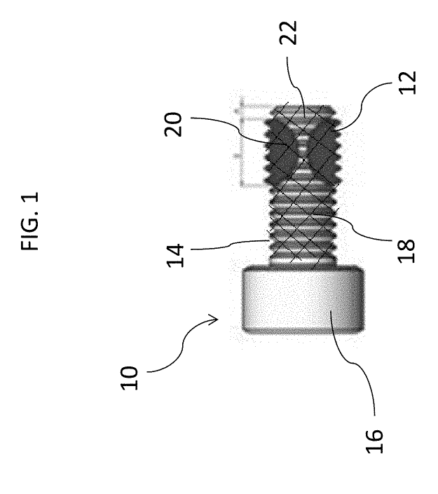

FIG. 1 shows a threaded fastener 10 having a hybrid locking mechanism or patch 12 for increasing retention strength and resistance to loosening and/removal formed thereon, according to one embodiment described herein. The threaded fastener 10 may be, for example, a bolt or a screw, and is preferably formed of metal material, such as, but not limited to, steel or carbon steel. The threaded fastener 10 may alternatively, or in addition, include metal plating. In one embodiment, the threaded fastener 10 may be approximately 0.8 millimeter (mm)-1.7 mm, depending on a particular application or size requirement. However, it is understood that the present disclosure is not limited to such fasteners, and that the features and techniques described herein are applicable to fasteners of various sizes.

In one embodiment, the threaded fastener 10 includes a shank 14, and optionally includes a head 16. The shank 14 includes threads 18 extending along at least a portion of its length. The hybrid locking mechanism or patch 12 may include a first locking mechanism 20 and a second locking mechanism 22 (shown as meshing lines over the shank 14). In one embodiment, the first locking mechanism 20 may be a mechanical locking mechanism and the second locking mechanism 22 may be a chemical locking mechanism. The first and second locking mechanisms 20, 22 are preferably disposed on the threads 18 of the shank 14. In one embodiment, the mechanical locking mechanism 20 may be a first patch, such a polymer patch deposited on the shank 14, and the chemical locking mechanism may be a second patch, such as an adhesive, coated on the shank 14. It is understood that in the present disclosure, the terminology “patch” refers interchangeably to patches, pellets, strips, coatings and other similar depositions on the shank 14 provided to increase retention strength and resistance to loosening or removal of the threaded fastener from a mating threaded component.

In one embodiment, the mechanical locking mechanism 20 may be made of a polymer material. In one embodiment, the polymer may be a thermoplastic material such as nylon and the like. For example, in one embodiment, the mechanical locking mechanism 20 may be formed from nylon 11. However, other materials are envisioned as well, including, but not limited to a polyphthalamide (PPA) resin, such as NYTEMP®. In one embodiment, the polymer material may be a thermoset material. Further, in one embodiment, the polymer material may include a blend of thermoplastic and thermoset materials. Further still, in one embodiment, different mechanical locking mechanisms 20 may be formed from different materials or different formulations than other mechanical locking mechanisms 20 formed on the same fastener 10.

The mechanical locking mechanism 20 may have a substantially circular shape. However, the mechanical locking mechanism 20 is not limited to this shape. In addition, the mechanical locking mechanism 20 may be formed on the shank 14 and have various diameters or sizes as desired for a particular application. Further, multiple mechanical locking mechanisms 20 may be formed at various locations on the shank 14. The mechanical locking mechanisms 20 may be discrete from one another, or one or more mechanical locking mechanisms 20 may partially overlap with one another. Alternatively, or in addition, the mechanical locking mechanism 20 may extend completely around the shank 14.

During installation, the mechanical locking mechanism 20, creates a wedge between the threaded fastener 10 and the mating threaded component, compressing the material. Due at least in part to a resiliency of the material of the mechanical locking mechanism 20, the mechanical locking mechanism 20 urges adjacent regions of the threads 16, free of the mechanical locking mechanism 20, into contact with threads of the mating threaded component. Accordingly, a retention force, or resistance to loosening and/or removal, may be increased compared to regular, non-coated or otherwise non-treated, bare fasteners.

The chemical locking mechanism 22 may be an adhesive coating covering at least a portion of the shank 14 of the threaded fastener 10. In one embodiment, the adhesive covers the entire or substantially the entire threaded portion 18 of the shank 14. The chemical locking mechanism 22 may be a multi-part chemical adhesive and may include a plurality of microcapsules (not shown). In one embodiment, the microcapsules include a first set of microcapsules containing a first part, e.g., a resin, and a second set of microcapsules containing a second part, e.g., a hardener. For example, in one embodiment, the first set of microcapsules may contain an acrylic resin and the second set of microcapsules may contain a peroxide hardener. In another embodiment, the first set of microcapsules may contain an epoxy resin and the second set of microcapsules may contain an epoxy hardener. The microcapsules may be carried in a carrier, such as a solvent based carrier or a water based carrier in slurry or paste form. In another embodiment, the liquid slurry or paste may contain only one of the first set of microcapsules and the second set of microcapsules, and the other of the first set of microcapsules and second set of microcapsules may be applied to the shank 14 later, or applied to a mating threaded component to which the threaded fastener 10 is configured to engage. Other microencapsulated adhesives, in one part or two part form, are envisioned as well.

In one embodiment, the microcapsules, including the first set of microcapsules and the second set of microcapsules, are disposed on the shank 14. When the shank 14 is installed in the mating threaded component, contact between the mating threaded components causes the microcapsules to crush and release the contents held therein. The contents of the microcapsules may then mix together, causing a chemical reaction, and subsequent hardening or curing of the adhesive. Accordingly, the adhesive may increase retention strength and resistance to loosening or removal of the threaded fastener in the mating threaded component. In another embodiment, only one of the first set and second set of microcapsules may be applied on the shank 14, and the other is applied on a mating threaded component, such that contact between the shank 14 and mating threaded component causes the microcapsules of the first and second sets to crush and release the contents held therein. The contents may then mix, causing a chemical reaction and subsequent hardening or curing of the adhesive.

In one embodiment, the mechanical locking mechanism 20 is applied on the shank 14. The chemical locking mechanism 22 is then applied over the mechanical locking mechanism 20 and surrounding bare portions of the threads 18. Upon installation in the mating threaded component, the mechanical locking mechanism 20 urges the threads 18 of the threaded fastener 10 into engagement, or tighter engagement, with the corresponding threads of the mating component. Simultaneously, the microcapsules of the chemical locking mechanism 22 break and mix together, such that the contents of the microcapsules, i.e., the adhesive components, flows between the threads of the threaded fastener and the corresponding threads of the mating component.

After curing, the chemical locking mechanism 22, e.g., the adhesive, provides an initial or primary retention strength and resistance to loosening and/or removal of the threaded fastener 10 within the mating threaded component. The mechanical locking mechanism 20 provides a secondary retention strength, or resistance to loosening or removal of the threaded fastener 10, supplementing the initial or primary retention strength.

To remove the threaded fastener 10 from the mating threaded component, the retention force of the chemical locking mechanism 22 may first be overcome by applying a first torque to the threaded fastener 10. Subsequently, the retention force of the mechanical locking mechanism 22 may be overcome by applying a second torque to the threaded fastener 10.

Upon a second, or subsequent installation of the threaded fastener 10 in the mating threaded component, the retention strength of the chemical locking mechanism 22 is essentially nullified, because the adhesive will no longer cure to form a bond between the threaded fastener 10 and the mating threaded component. However, the mechanical locking mechanism 20 may continue to function as described above to provide retention strength and resistance to loosening and/or removal of the threaded fastener 10. Thus, in second, or subsequent uses, the mechanical locking element 20 is the source of the primary retention strength to hold the fastener 10 against unintentional loosening and/or removal.

To manufacture the threaded fastener 10 having the hybrid patch 12 according to the embodiments described herein, the threaded fastener 10 may be preheated to a desired temperature. In one embodiment, the threaded fastener 10 is heated to a temperature sufficient to melt the material of the mechanical locking mechanism 20 upon application of the material on the fastener 10. Accordingly, the melted material flows as a low viscosity fluid into the threads and solidifies upon cooling. In one embodiment, the melted material flows into the base or roots of the threads. For example, where the material is nylon 11, the threaded fastener 10 may be preheated to a temperature of about 525 F-550 F, to melt the nylon 11 upon application to the threaded fastener. It is understood that the present disclosure is not limited to this range, however, and other suitable preheat temperatures for the fastener 10 are envisioned. For example, other preheat temperatures suitable to heat the nylon 11 material above approximately 376 F are envisioned as well. In another embodiment, where PPA is used as the patch material, the threaded fastener 10 may be preheated to a temperature of about 700 F. However, other preheat temperatures or ranges are envisioned, including temperatures suitable to heat the PPA above approximately 602 F upon application to the fastener 10. Preferably, the threaded fastener is preheated to a temperature suitable to heat the material sufficiently beyond its melting point to adequately reduce viscosity and allow free flow between the threads. That is, in one embodiment, the temperature to which the fastener 10 is preheated is sufficient to cause the material, upon application to the fastener 10, to melt beyond an initial melting phase, such that the material has a lower viscosity than in the initial melting phase.

The material of the mechanical locking mechanism 20 may initially be in a powder in form, and is dispensed from an applicator (not shown) onto the shank 14 of the threaded fastener 10. In one embodiment, the applicator includes one or more nozzles (not shown) configured to dispense the material of the mechanical locking mechanism 20. The nozzles may dispense the material using known techniques, such as dispensing the material in a stream of air directed at the threaded fastener 10. After application of the powdered material onto the shank 14, the powdered material melts in response to the temperature of the shank 14, flows into the threads and adheres to the shank 14 to form the mechanical locking element 20.

In one embodiment, a material of the chemical locking mechanism 22 may be initially prepared as a liquid adhesive slurry having a carrier, such as a solvent-based or water-based carrier and the first and/or second sets of microcapsules. The liquid adhesive slurry is then applied to the threaded fastener 10 over the threads 18 of the shank 14. In one embodiment, the adhesive slurry extends over the mechanical locking mechanism 20. The adhesive slurry may also extend completely around a circumference of the shank 14. As the carrier dries, e.g., as the solvent based carrier evaporates, a coating of the first and/or second sets of microcapsules remains on the shank 14, to form the chemical locking mechanism 22. That is, the chemical locking mechanism 22 may be a one part mechanism where only one of the first set or second set of microcapsules are disposed on the fastener 10, or a two part mechanism where both of the first set and the second set of microcapsules are disposed on the fastener 10. In the one part mechanism, the other of the first set and second set of microcapsules may be disposed on a mating threading surface, or later applied to the fastener 10. Together, the mechanical locking mechanism 20 and the chemical locking mechanism 22 form the hybrid locking element or patch 12.

Accordingly, in the embodiments described herein, the mechanical locking mechanism 20, for example, a polymer patch, may continue to provide a degree of mechanical locking, or resistance to loosening or removal, during second or subsequent uses of the threaded fastener 10. In addition, the chemical locking mechanism 22, initially provided as a liquid adhesive slurry, may serve as a lubricant to reduce a torque required to install the threaded fastener 10, and partially overcome increased resistance from the mechanical locking mechanism 20. Further, microcapsules of the chemical locking mechanism 22 disposed over the mechanical locking mechanism 20 may be subjected to stronger friction and compression forces between the threaded fastener 10 and mating threaded component, compared to microcapsules at other locations on the shank 14, thereby increasing efficiency in the breaking of the microcapsules and mixing the contents of the microcapsules.

Further, in the embodiments above, the mechanical locking mechanism 20 may provide a degree of resistance against loosening and/or removal while the chemical locking mechanism 22 cures, thereby reducing machine or component down time. The chemical locking mechanism 22, upon curing, may provide a higher retention strength or resistance to loosening and/or removal than the mechanical locking mechanism 20 alone.

The threaded fastener 10 having the hybrid locking mechanism or patch 12 described herein may be especially beneficial for “in the field” repairs, for example, in electronics, because the fasteners 10 may be reused while retaining locking functionality, without reapplying adhesive to the fasteners 10. Further, the chemical locking mechanism 22 may provide improved locking characteristics during initial use of the threaded fastener 10, especially in applications where the threaded fastener 10 includes only one or two threads.

It is understood that the features from any of the embodiments described herein may be combined with, or replace features of other embodiments described herein, without deviating from the scope of this disclosure.

All patents referred to herein, are hereby incorporated herein in their entirety, by reference, whether or not specifically indicated as such within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A threaded fastener with a hybrid locking mechanism, comprising:
a shank having a threaded portion;
a first locking mechanism disposed on the threaded portion; and
a second locking mechanism, different from the first locking mechanism, disposed on the threaded portion extending over the first locking mechanism,
wherein the first locking mechanism provides a primary retention strength during an initial use of the threaded fastener, and the second locking mechanism provides the primary retention strength during subsequent uses of the threaded fastener.

2. The threaded fastener of claim 1, wherein the first locking element is a mechanical locking element.

3. The threaded fastener of claim 2, wherein the mechanical locking element is one or more polymer patches.

4. The threaded fastener of claim 3, wherein the one or more polymer patches are formed from a thermoplastic.

5. The threaded fastener of claim 4, wherein the one or more polymer patches are formed from one or more of: nylon, nylon 11 and polyphthalamide.

6. The threaded fastener of claim 3, wherein the one or more polymer patches are formed from a thermoset.

7. The threaded fastener of claim 1, wherein the second locking mechanism is a chemical locking mechanism.

8. The threaded fastener of claim 7, wherein the chemical locking mechanism is an adhesive.

9. The threaded fastener of claim 8, wherein the adhesive comprises at least one of a first set of microcapsules containing a resin and a second set of microcapsules containing a hardener.

10. The threaded fastener of claim 9, wherein the adhesive comprises both the first set of microcapsules and the second set of microcapsules.

11. A method of making a threaded fastener with a hybrid locking mechanism, the threaded fastener comprising a shank having a threaded portion, a first locking mechanism disposed on the threaded portion, and a second locking mechanism disposed on the threaded portion extending over the first locking mechanism, the method comprising:
applying a first locking mechanism material on the shank; and
applying a second locking mechanism material, different from the first locking mechanism material, over the first locking mechanism material on the shank.

12. The method of claim 11, wherein the shank is preheated to a desired temperature before the first locking mechanism material is applied thereto.

13. The method of claim 12, wherein the first locking mechanism material is in powdered form when applied to the shank.

14. The method of claim 13, wherein the first locking mechanism material is adhered to the shank, in response to the temperature of the shank, to form the first locking mechanism.

15. The method of claim 11, wherein the first locking mechanism material is formed from a thermoplastic.

16. The method of claim 15, wherein the first locking mechanism material is one or more of: nylon, nylon 11 and polyphthalamide.

17. The method of claim 11, wherein the first locking mechanism material is formed from a thermoset.

18. The method of claim 11, wherein the second locking mechanism material is applied to the shank as a liquid adhesive slurry or paste comprising an adhesive containing at least one of a first set of microcapsules and a second set of microcapsules in a carrier.

19. The method of claim 18, further comprising evaporating the carrier from the shank to leave the microcapsules deposited on the shank.

20. The method of claim 18, wherein the first set of microcapsules contains a resin and the second set of microcapsules contains a hardener.
